(19) United States
(12) Patent Application Publication
(10) Pub. No.: US 2009/0304161 A1
(43) Pub. Date: Dec. 10, 2009

(54) SYSTEM AND METHOD UTILIZING VOICE SEARCH TO LOCATE A PRODUCT IN STORES FROM A PHONE

(76) Inventors: Nathan Marshall Pettyjohn, Saint Louis, MO (US); Matthew Paul Kulig, Millstadt, IL (US)

Correspondence Address: Matthew Kulig, 915 Lanyard, St. Louis, MO, 63122, US

(21) Appl. No.: 12/134,187

(22) Filed: Jun. 5, 2008

(51) Int. Cl. H04M 1/64

(52) U.S. Cl. 379/88.01

(57) ABSTRACT

A system and method for providing automatic voice recognition and voice response product location information in a store while using a personal mobile phone or any phone connected to a telecommunications or data communications network such as and including the Internet and an automatic speech recognition system. The system 403 & 404 asks a user and/or customer 300 a series of automated questions to help the user and/or customer 300 locate products in stores. In the embodiment of the invention, the user and/or customer 300 only needs to dial the toll free or dial in number 302 from any phone to use the system in order to receive the requested product location information or other available information by the automated response system. This invention creates the product location assistance (PLA) system to be used in locating products in stores, creating new efficiencies in customer service for retailers, businesses and organizations.

### FEDERALLY SPONSORED RESEARCH

Not Applicable

### SEQUENCE LISTING OR PROGRAM

Not Applicable

### BACKGROUND OF THE INVENTION

1. Field of Invention

This invention creates a voice search product location assistance (PLA) system and method for locating products in stores, businesses and/or organizations dialing a phone number and using an automatic speech recognition system.

2. Prior Art

The present invention creates a system and method for users and/or customers to locate products in stores and additional requested information using a user's and/or customer's personal mobile phone or a phone system connected to a telecommunications network such as and including the Internet, a commercially branded toll free or dial in number and voice request & voice response system called an automatic speech recognition system which includes interactive voice response tools that use speech to text and text to speech methods. The branded toll free or dial-in number connects users and/or customers to the automatic speech recognition system to receive the product location information. The automatic speech recognition system accesses the stores inventory and/or plan-a-gram information through a converted inventory data standard formatted for integration with a text to speech and speech to text program loaded on a server creating a real-time voice prompt giving the user and/or customer a product location. The user and/or customer can search by product description and/or product brand name. Traditional directory assistance services allow callers to get phone numbers and address information from their phones. This invention, utilizes new unique systems and methods for gathering, formatting, accessing, and interacting with product data, moving the assistance system concept to the product level in the stores, creating a product location assistance (PLA) system.

Known prior art allows customers or users to access kiosks, internal phone systems, mobile text messaging, mobile internet programs and internet connected computers to access a variety of information programs using voice or text search methods to locate product inventory or product pricing from the Internet. There currently exist many phone dial-in systems that use automatic speech recognitions for customer service functions such as directory assistance systems. However, there is currently not a system or method that allows users to access the product location in a store and additional information from an automated voice based automatic speech recognition system using the user's and/or customer's personal phone devices while in the store or anywhere the user and/or customer wants to retrieve the information.

For those skilled in the art, the novelty of this invention is a user's and/or customer's ability to use a personal phone device to access product information using a commercially branded toll free or dial in number, and a voice request and voice response systems to retrieve the product location and additional information over the phone. This method allows the user and/or customer to ask for and receive information via the automatic speech recognition system to locate the product while in the store or from any type of phone, using the toll free or dial in number.

The following prior art patents represent various inventions relating to machines, systems and methods involving product locators, speech recognition for voice-based operation, and thus illustrate known voice recognition applications for use in asking for and receiving information using automatic speech recognition systems:

U.S. Pat. No. 5,111,501 describes a telephone terminal device equipped with a transmitter microphone, a receiver, a speech recognition unit that receives and recognizes speech signals from the transmitter microphone.

U.S. Pat. No. 5,222,121 describes a voice recognition dialing unit of a telephone mounted on a vehicle or similar mobile body and which allows a call to be originated with ease.

U.S. Pat. No. 5,231,670 describes a system and method for generating text from a voice input that divides the processing of each speech event into a dictation event and a text event.

U.S. Pat. No. 5,671,328 describes a method and data processing system which are disclosed for automatically creating voice processing template entries.

U.S. Pat. No. 5,850,627 describes a word recognition system which can: respond to the input of a character string from a user by limiting the words it will recognize to words having a related, but not necessarily the same, string.

U.S. Pat. No. 6,092,045 describes matching unknown speech with known models to perform speech recognition.

U.S. Pat. No. 6,157,705 provides a method for controlling a server using interactive voice response system thereby requesting information stored on the server and receiving the information visual from a remote server.

U.S. Pat. No. 6,533,173 provides a product locator that is a computer mounted to a shopping cart that receives data from a second computer. It allows a customer to receive location information about products using the computer.

U.S. Pat. No. 6,807,574 creates a method and apparatus for providing personalized information content over telephones and establishes a user profile based upon unique identifying information.

U.S. Pat. No. 6,813,341 provides a voice system to locate items using a specific software module and in store internal connector locator system. The system's information can only be accessed using an internal system of portable devices, specifically short distance wireless devices. This patent does not offer a system or method for users and/or customers to use any phone and a dial in number to locate the product information from anywhere.

U.S. Pat. No. 7,016,845 provides a method of providing speech recognition resolution on an application server in a communication network includes receiving an utterance from an end-user. The method further includes performing item-matching via a search algorithm, returning items matching the utterance to the application server, and returning relevant utterance matches to the application user.

U.S. Pat. No. 7,027,987 provides a system for search results from a voice search query. The system receives a voice search query from a user, derives one or more recognition hypotheses, each being associated with a weight, from the voice search query, and constructs a weighted Boolean query using the recognition hypotheses. The system then provides the weighted Boolean query to a search system and provides the results of the search system to a user.

U.S. Pat. No. 7,082,392 relates to the management, in an interactive voice response system, of a plurality of speech technology modules. In particular it relates to an apparatus and a method for dynamically determining which of a plurality of speech technology modules to use during voice interaction between the system and a user.

U.S. Pat. No. 7,194,069 creates a system for providing access to data via a voice interface.

U.S. Pat. No. 7,343,290 concerns a method of switching from one original dialog system, to a target dialog system, whereby the language of the speech recognition and/or speech output unit, of the target dialog system can be set.

U.S. Pat. No. 7,366,668 creates a system to provide search results from a voice search query. The system receives a voice search query from a user, derives one or more recognition hypotheses, each being associated with a weight, from the voice search query, and constructs a weighted Boolean query using the recognition hypotheses. The system then provides the weighted Boolean query to a search system and provides the results of the search system to a user.

This prior art, known by the inventors, creates automatic speech recognition systems and product locators using in store communication systems, text to speech and speech to text conversions for voice and data for the purposes of locating information desired by the user. It also creates query organization for ranked responses to requests. It does not allow the user and/or customer to request specific product location information from their personal phone. It does not specifically create the systems and methods claimed in this patent.

In addition, the following patent applications propose system and methods for a voice system to process and provide information to users and or customers.

U.S. Patent Applications 20040228456 creates an item location system which relies upon voice activation and responsiveness to identify location(s) of item(s) sought by a user.

U.S. Patent Application 20050090931 creates a method for using bar code readers to establish product location directories for use in product locator systems.

U.S. Patent Application 20070038445 creates a device to improve speech recognition accuracy by utilizing an external knowledge source.

U.S. Patent Application 20070033025 creates a method of improving speech recognition includes receiving a plurality of recognized sentences from an automatic speech recognition engine.

U.S. Patent Application 20070165795 creates a system and method for providing SMS, MMS and/or WAP information to a mobile unit user in response to a request made by the user using an interactive voice response (IVR) system. This Patent Application does not provide an interactive product location assistance (PLA) system.

U.S. Patent Application 20070263796 creates a method and system to provide data to an Interactive Voice Response (IVR) System.

The inventors are also aware of recent improvements in voice recognition technologies and testing utilized recently for one of the newer free directory assistance systems. The information is covered in the white paper: “Deploying GOOG-411: Early Lessons in Data, Measurement, and Testing” by Michiel Bacchiani, Francoise Beaufays, Johan Schalkwyk, Mike Schuster, Brian Strope at Google, Inc. The system uses mapping technologies to provided directory assistance information to user of the service.

Notwithstanding the entire prior art listed, the present invention is neither taught nor rendered obvious by these patents and patent pending documents or white papers.

### SUMMARY

The system and method for locating products by dialing a number from any phone and accessing an automatic voice recognition system that provides product location information in the store using the store's product location data that is converted to automatic voice responses. Product searches can be requested by product descriptions and/or product brand names.

### DRAWINGS—FIGURES

FIG. 1 shows the data formatting and the text to speech and speech to text conversion system which generates the voice responses of the automatic voice response system to provide the user the automated voice responses. The data is formatted and updated by retailer inventory systems by batching their information with the systems information.

FIG. 2 shows the computer server or workstation and all its components that allow an automatic speech recognition system, including an interactive voice response system, and speech to text and text to speech to run and interface with the user and/or customer.

FIG. 3 shows the method for dialing into automatic speech recognition systems using a toll free or dial in number to request product location information in a store. The product location information is stored in servers using automatic speech recognition systems, including interactive voice response tools that use speech to text and text to speech methods to create automated voice responses to users inquires.

FIG. 4 shows the process the user and/or customer goes through to ask for and receive product location information and other requested information in the store provided by the system. A series of questions is asked by the automatic speech recognition system to route the user and/or customer to the correct store location to find the product in that particular store location.

FIG. 5 shows the operation of system method from the user and/or customer using the automatic speech recognition tools in the system to search, locate and have the system create a real time voice prompt for the user and/or customer in answer to their product location request and other requested information provided by the store.

### REFERENCE NUMBERS

100 Retailer Inventory data
101 Data Formatting tools
102 Text to Speech conversion tool
103 Speech to Text conversion tool
200-245 Parts of a Server
300 User and/or Customer
301 Telecommunications network
302 Toll free or Dial-in number
305 Network
306 Automatic speech response server
401 User Language Question
401 User City and State Question
403 ASR store location interaction
404 ASR product location interaction
406 Automatic speech responses
408 User Store Question
410 User Product Question
412 User Additional Help Question
414 Call Terminates

### DETAILED DESCRIPTION—PREFERRED EMBODIMENT

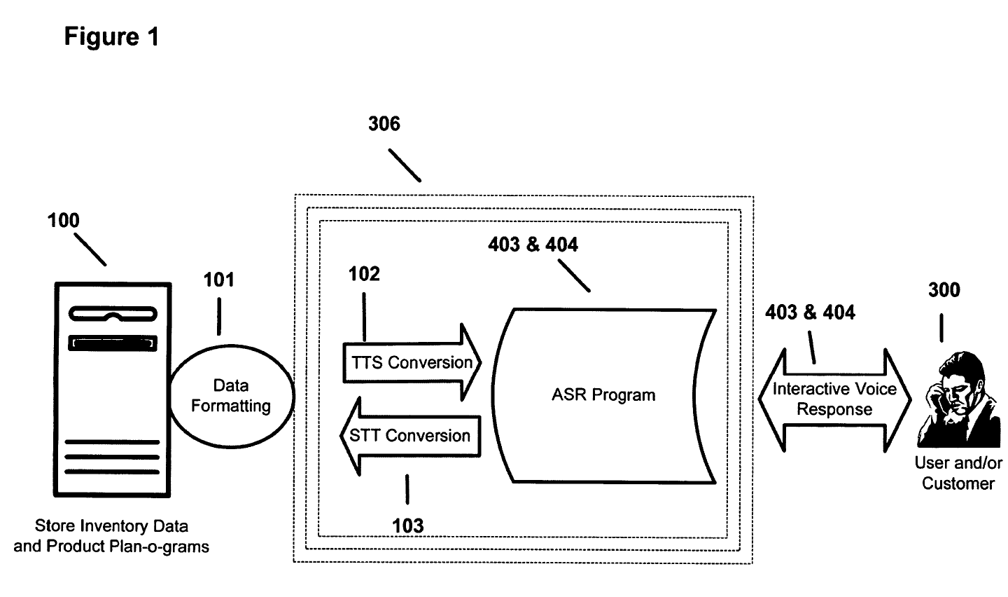

The invention creates a way for users and/or customers to access and receive product location and other provided information while shopping in the store using their mobile phone. To accomplish this task, FIG. 1 shows the first step in the system and method. The store's inventory data and plan-a-gram information 100 is converted 101 to a data format that allows text to speech 102 tools to create automated voice responses. Text to speech 102 and speech to text 103 tools are used to find the correct data and create the voice prompts giving product location information, which are stored on the automatic speech recognition system 403 and 404 located on a computer server 306 to provide the requested product location and additional information to the user and/or customer when they call the system. The system can be updated, via batching, when the retailer updates their internal systems to create up to date inventory information.

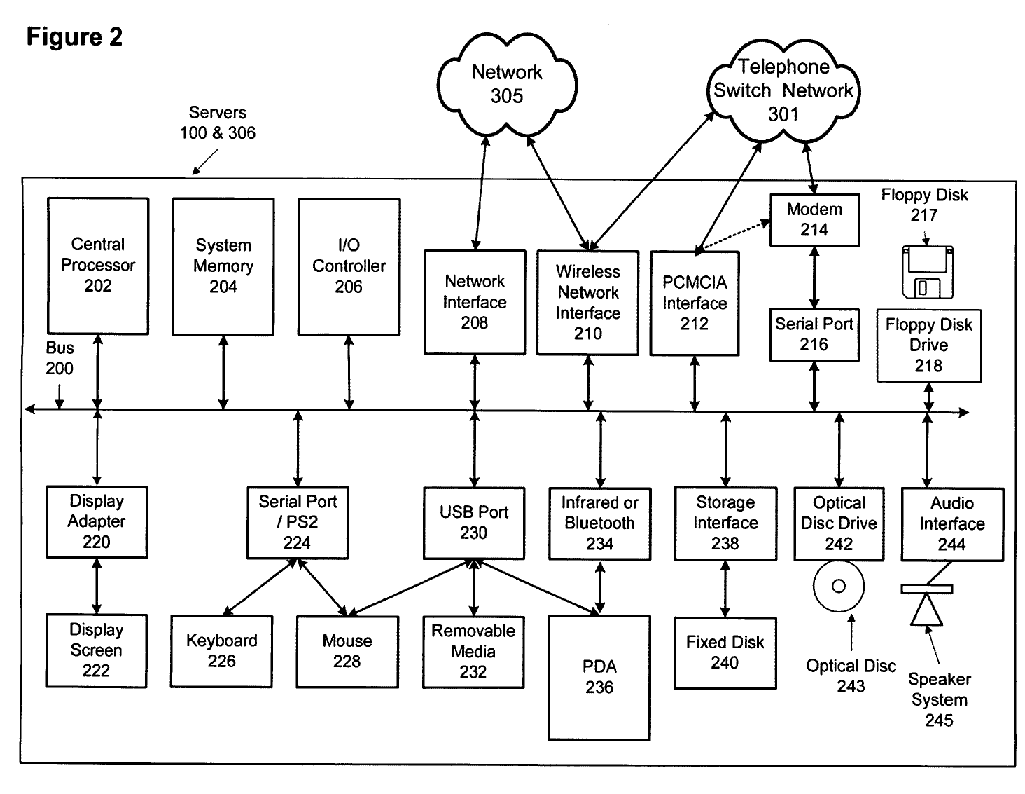

FIG. 2 shows the various components of a computer server or workstation 200-245 that allows it to load and run the software required to accomplish the task needed to perform the system and method. It also shows the network 305 and telephone network connections 301 that allow it to interface with a routing network.

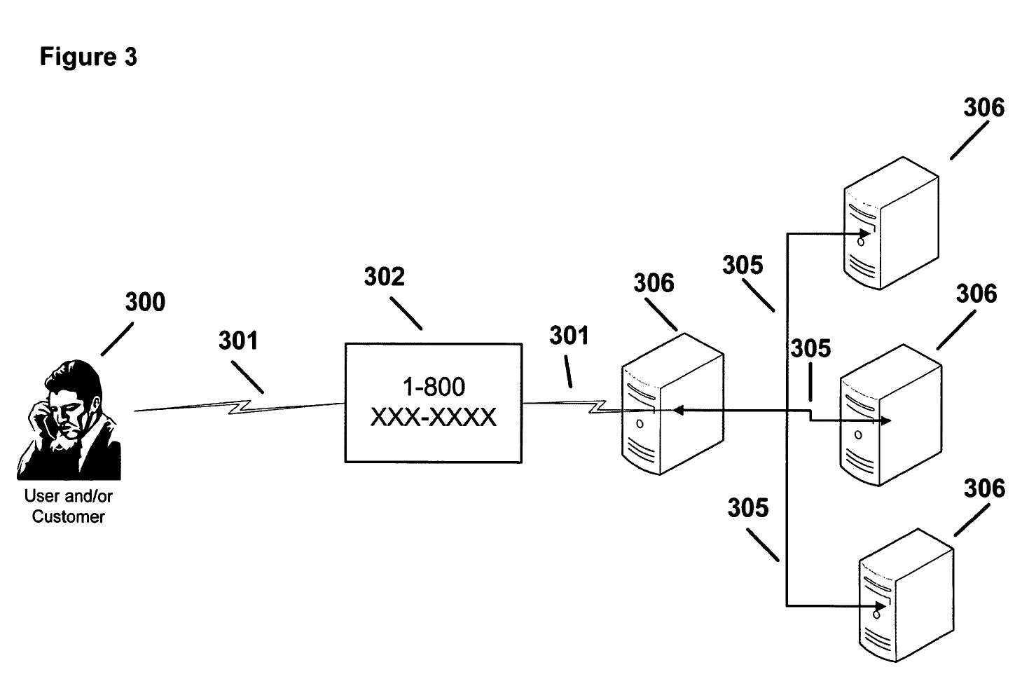

FIG. 3 depicts the process of using the system and the flow of information in the method.
1. A user and/or customer 300 using a phone dials a toll free or dial in number 302 which connects them to a bank of servers 306 using the automatic speech response system 403 & 404.
2. The automatic speech response system 403 & 404, via a series of automated questions and answers, provides the user and/or customer 300 with requested information as to where the product is located in the store. The user and/or customer 300 can request product information by product description and/or product brand name. This system via the stores request can provide additional information such as current pricing, inventory counts, next shipment date, product specifications and other inventory information 100 provided by the store to the text to speech 102 tools to create automated real time prompts from the stored data.
3. The servers 306 can be program to understand multiple languages requested by the store for their customers.
4. The user and/or customer 300 can continue requesting additional product location information until the call is terminated.

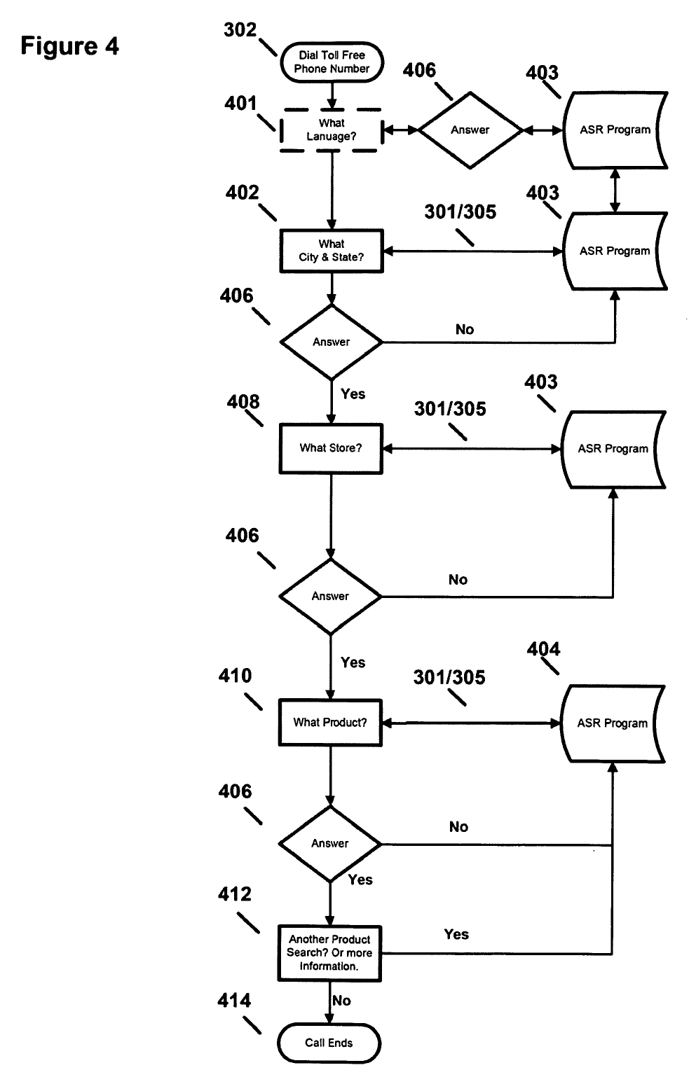

FIG. 4 represents the flow diagram of the system and method for locating a product using the process. The system is automated and connected to a bank of servers that are running the automatic speech recognition systems. It asks a series of questions, language choice 401, city and state 402, store name 408 and product 410. Based upon the user and/or customer responses 406, it provides the appropriate data and using a text to speech tool creates a voice response for the requested product location.

The language question is only requested by the system the first time a user and/or customer uses it. The system matches the language choice of the user and/or customer to the number from which the user and/or customer is calling and always uses that language choice when called from that number unless specifically requested otherwise within the system by the user and/or customer. This eliminates the need to prompt the user for language choice after the first time using the system.

### EXAMPLE

A user and/or customer 300 calls a branded toll free number or dial-in number 302 and hears from the automatic speech response system:

What language? 401 The user and/or customer 300 responds: English. The system 403 chooses the server bank with English. This is the language always used when the caller calls the system 403 and the appropriate server bank 306 is matched to the phone number.

What City and State? 402 The user and/or customer 300 responds: Chicago, Ill. The system 403 matches the answer (yes) and chooses the appropriate server bank 306 for Chicago, Ill. If the system 403 can not match the answer (no) it prompts the user with the same question 402.

What Store? 408 The user and/or customer 300 responds: Store Name. The system 403 matches the answer (yes) or provides more information to select the particular store location (no) or does not match (no) and asks the question again 408.

What Product? 410 The user and/or customer 300 responds: duct tape or 3M or 3M duct tape. The system 404 matches the answer (yes) and provides the correct location and other information provided by the store or provides information that the product is not in the store. If the system 404 does not match the answer (no), it will ask the question again 410.

Once the user and/or customer 300 receives the information requested, the system 404 will ask if the user and/or customer 300 needs to locate another product or requires more information 412. If yes, it will return to the user and/or customer 300 to question 410. If no, the call will terminate 414.

If the user and/or customer 300 hang up the phone anytime during the call, the call will terminate 414.

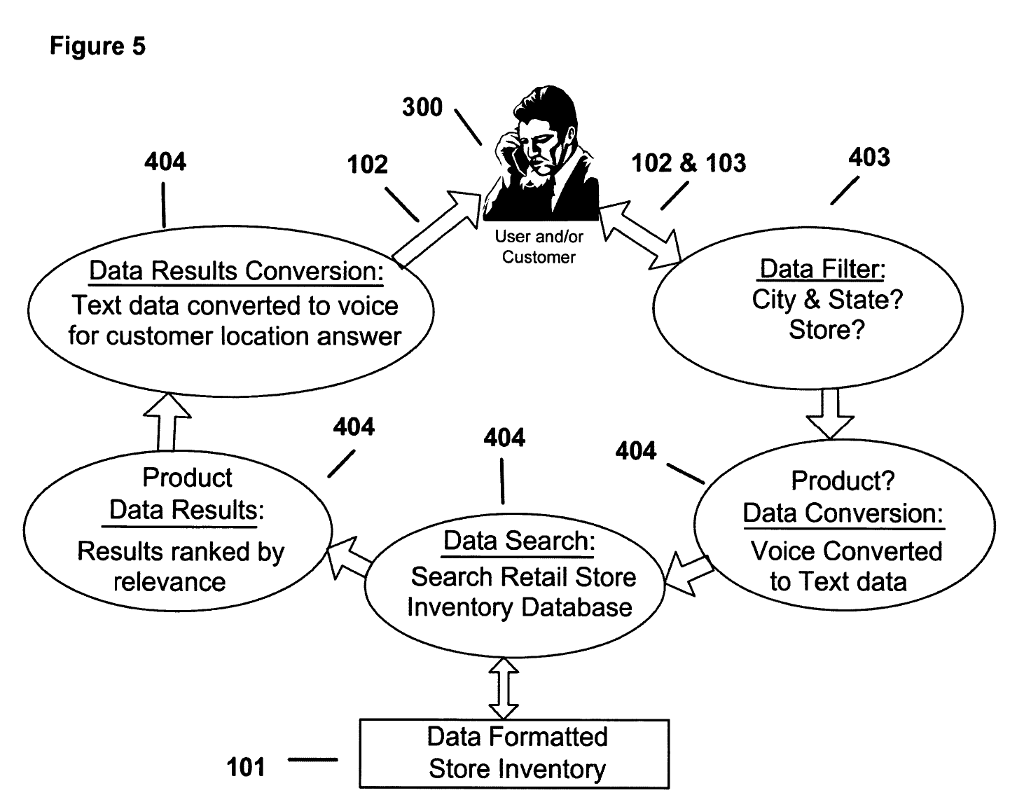

FIG. 5 represents the operation of the system from the user and/or customer 300 through the automatic speech response system 403 and 404. The system through a series of questions on 403 using speech to text 103 and text to speech 102 systems routes the user and/or customer to the correct location and correct store inventory data 404 that had been created from 101. Once the automatic speech response system 404 matches the correct item it creates a voice response using a text to speech tool 102 for the user and/or customer based upon the user and/or customers requested match.

This is the embodiment of the product location assistance (PLA) system, which can be added to existing and/or new directory assistance systems as an additional level of information for users and/or customers to access.

### Conclusion, Ramifications and Scope

Accordingly, the reader can see that this system and method provides a dial-in interactive voice response system 403 & 404 specifically designed to locate products and product information in stores from any phone anywhere. The user and/or customer 300 product requests can be by product description and/or product brand name or both. No software or hardware other than the user's and/or customer's 300 phone is required to use the system. This allows the user and/or customer 300 to help locate products in stores themselves, creating new efficiencies in customer services.

We claim:

1. A system and method for requesting and receiving product locations within stores, businesses and/or organizations using a personal mobile phone or any phone connected to a telecommunications and/or data communication network such as and including the Internet, a branded toll free or any dial in number and automatic speech response system.

2. A system and method in claim 1 to requesting product information by product description and/or by product brand name or by both brand name and description.

3. A system and method in claim 1 for accessing and requesting additional product information such as inventory numbers, pricing, product availability, product specifications and other relevant user requested data managed by the system.

4. A system and method in claim 1 that uses a branded toll free or any dial in number for access from anywhere.

5. A system and method in claim 1 that allows a user to request the information using computer generated voice response prompts.

6. A system and method in claim 1 that uses voice recognition technology to process user product requests.

7. A system and method in claim 1 offers additional information provided by the store including product suggestions related to the product.

8. A system and method in claim 1 for accessing and requesting voice automated directions to a product location from a said stationary point from within a business or organization.

9. A system and method for converting inventory data and product location information into automated voice prompts accessible by any phone connected to a telecommunications network.

10. Data in claim 9 can be converted into multiple languages.

11. Data in claim 9 offers additional information provided by the store including product suggestions related to the product.

12. Data in claim 9 for accessing and requesting voice automated directions to a product location from a said stationary point from within a business or organization.

13. A system and method that, upon the first call into the system, matches the language choice of the user and/or customer to the number from which the user and/or customer is calling and always uses that language choice when called from that number unless specifically requested otherwise within the system by the user and/or customer. This eliminates the need to prompt the user for language choice after the first time using the system.
